(19) United States
(12) Patent Application Publication
(10) Pub. No.: US 2020/0342088 A1
(43) Pub. Date: Oct. 29, 2020

(54) A SYSTEM AND METHOD FOR DEVELOPING AUTHENTICATION DATA AND AN ELECTRONIC DEVICE FOR RESPONDING TO AN AUTHENTICATION REQUEST FROM SUCH A SYSTEM

(71) Applicant: Phone Pass Pty Ltd, Griffith (AU)

(72) Inventors: Denis John Jorgensen, Griffith (AU); Shantanu Bhattacharya, Conder (AU)

(73) Assignee: Phone Pass Pty Ltd, Griffith (AU)

(21) Appl. No.: 16/772,757

(22) PCT Filed: Oct. 17, 2018
(86) PCT No.: PCT/AU2018/051125

§ 371 Date: Jun. 12, 2020

(30) Foreign Application Priority Data
Dec. 13, 2017 (AU) 2017904996

(51) Int. Cl. G06F 21/35; G06F 21/40; G06F 21/44

(52) U.S. Cl. CPC G06F 21/35; G06F 2221/2129; G06F 21/44; G06F 21/40

(57) ABSTRACT

A system for providing authentication data for user devices. System includes a database storing first data, for each device, indicative of a first instance of the device characterization derived from static orientations of the respective devices. A system interface receives from a device, second data that is indicative of a second instance of the device characterization. An authentication module is responsive to the first and second data to selectively generate authentication data. A user device includes a device interface for: receiving a request to provide the second instance of the characterization; and transmitting a response. The user device also includes a reference module that provides a measurable output including a bias and a processor that is responsive to the request for: prompting module for the measurable output; producing the instance of the characterization based at least in part upon the measurable output; and generating the response containing second data.

### FIELD OF THE INVENTION

The present invention relates to a system and method for providing data and more particularly to a system and method for providing authentication data and an electronic device for responding to an authentication request from such a system.

Embodiments of the invention have been particularly developed for use in second-factor authentication by smartphones and the embodiments will be described herein with particular reference to that application. However, it will be appreciated that the invention is not limited to such a field of use and is more broadly applicable to other electronic devices involved in identification and/or authentication processes.

### BACKGROUND

Any discussion of the background art throughout the specification should in no way be considered as an admission that such art is widely known or forms part of common general knowledge in the field.

There are a number of authentication systems available for users of the internet, where each user is typically a human interacting with one or more electronic devices or an electronic device per se. The primary form of authentication remains the use of pre-defined passwords for the devices themselves, application software run on the devices, or for online sites accessed via the devices.

The current authentication systems suffer from serious downsides both for electronic devices operated by humans and for standalone devices that are internet enabled. Such standalone devices do not necessarily require human input to perform at least a subset of operations with external devices or networks, and often will operate independently of human input.

As an example of the challenges being faced, those passwords used by humans to access electronic devices, online sites and other connected devices are becoming more and more vulnerable. As computing power increases, users are being asked to choose longer and more complicated passwords to prevent computer-powered ‘brute force’ guessing attacks. There is a practical limit to the complexity of passwords that users can formulate and easily and reliably remember. Additionally, users are also being asked to regularly change passwords, further reducing the ability of individuals to remember what password is currently used and where it is used. Stolen password databases show that: users often choose easy to guess passwords; and users often reuse the same password on multiple devices and/or sites. This makes multiple user devices or online accounts for that user more susceptible to a successful attack. That is, attackers are able to use passwords registered with a first site to attack or gain unauthorised access to a user's account on a second site.

Passwords for standalone devices are also problematic. While devices do not ‘forget’ passwords, in the event of that a password for such a device is compromised it is often difficult to securely update the password without physical accessing the device. As the number of such devices connected to the internet grows, especially with the rise of the Internet of Things (IoT) the risk and the difficulty correspondingly grows. Often devices are shipped to users with default passwords with the expectation that users will update the password to something unique and secure. Experience has demonstrated that in many instances default passwords are not updated, or not updated with sufficiently strong passwords, leaving the device vulnerable. At scale, particularly in an industrial or metropolitan deployment, the process of selecting, setting and then securely administering passwords for large numbers of distributed devices is in and of itself challenging. It will be appreciated that methodologies used to update passwords remotely involve inherent risk since the same method that facilitates the updating will also present an opportunity to attack the electronic device and compromise its ongoing security.

In an effort to improve the authentication of electronic devices and users there has arisen a number of systems which allow users or devices to utilise more than one layer of authentication to improve the protection of sensitive transaction information.

Authentication is commonly based on three high level ‘factors’, these being:
Something a user is (such as a physical finger print or voice print).
Something a user knows (such as a password).
Something a user has (such as a hardware dongle, a physical token or a digital certificate).

Presently for humans the most common authentication mechanism is one-factor authentication (typically based on a password). The limitations of this form of authentication are able to be partly obviated by making use of two-factor authentication. The latter uses two of three factors sequentially to confirm authentication. A number of two-factor systems (generally a password and a token such as a hardware dongle) are known, but their adoption is far from widespread. A number of ‘one-and-a-half’ factor authentication systems are also known. These include systems using a combination of a password and a software client on a phone, and a confirmatory SMS message or email. These systems are more robust and secure than one-factor systems, but software clients, phone numbers, SMS messages and email accounts are all vulnerable because none strongly conform to the ‘something a user has’ rule. They are more correctly described as ‘some online resource that a user has access to’, and as such there exists an inherent vulnerability. If a password is compromised there is a high probability that connected accounts, such as smartphones or emails, will also be compromised, especially if the same password is used to access both, thereby giving the attacker access to the same online resource that the user has access to.

As a partial solution to this problem there are known processes for authenticating users with a two-factor system using hardware tokens or dongles. These are physical devices used to gain access to an electronically restricted resource. The tokens contain some kind of information which is used to prove identity. However, these tokens are vulnerable to theft or loss as well as man-in-the-middle attacks.

Existing two-factor systems suffer from many downsides that have hindered their proliferation. For example, the existing systems are typically expensive to install, administer and support. The hardware tokens are often expensive and require secure distribution, careful management and complex replacement protocols. Any organisations making use of such tokens also need to put in place procedures for managing lost tokens. This can involve teams of trained staff to administer the systems and field calls from users. Accordingly, any possible benefit from such systems can only in practice be realised for large organisations protecting assets with financial value. For individuals, small organisations, or relatively poorly funded organisations (that nevertheless carry extensive risk), it is more difficult to justify the high financial cost of implementing a two-factor system. An example of the latter would be a volunteer-run children's sporting association.

In more recent times consideration has been had to providing second-factor authentication for retail transactions involving a retailer and a purchaser. This has included harnessing the processing power of a smartphone operated by the purchaser. Examples include those disclosed in U.S. Pat. No. 8,447,272, U.S. patent application Ser. No. 13/681,588, and international patent applications WO 2015/058300 and WO 2016/087541. These forms of second-factor authentication can be inaccurate and suffer from poor repeatability. They often also necessitate the user to remember “something the user knows” such as a password, gesture or other movement.

Standalone devices also commonly use one-factor authentication, typically selected from either: something the device ‘knows’—such as a store password; or something the device has—such as a digital certificate or an electronic serial number such as mobile telephone International Mobile Equipment Identity. Both of these authentication methodologies have weaknesses which makes them difficult to apply to widespread standalone devices. In particular, the main problems associated with internet enabled device passwords are foreshadowed above. For digital certificates or electronic serial numbers, the main problems are that these identifiers are open to be changed or masked either through physical or remote connection with the device, or being stolen or copied. In many respects they have the same weaknesses as the ‘online resource a user has access to’ scenario discussed earlier. Accordingly, devices making use of such protections remain vulnerable to malicious attack and open to misuse. This impact is further heightened in the context of IoT devices, which are often employed, increasingly at massive scale, and managed without close human supervision, which allows any compromising of the device to remain covert for much longer than may have otherwise occurred.

Accordingly, there is a need in the art for an improved system and method for providing authentication data.

### SUMMARY OF THE INVENTION

It is an object of the present invention to overcome or ameliorate at least one of the disadvantages of the prior art, or to provide a useful alternative.

According to a first aspect of the invention there is provided an electronic device including:
a device interface for receiving an authentication request to provide an instance of a predetermined characterisation of the device; and transmitting a device response to the request;
a reference module that provides a measurable output including a bias; and
a processor that is responsive to the request for: prompting the module for the measurable output; producing the instance of the characterisation based upon the measurable output; and generating the device response containing second data that is indicative of the instance of the device characterisation.

In an embodiment the processor encrypts the second data.

In an embodiment the processor is responsive to the request for determining the nature of the prompting of the module.

In an embodiment the electronic device includes a plurality of reference modules, wherein the processor is responsive to the request for selecting one or more of the plurality of reference modules that is or are to be prompted for respective measurable outputs.

In an embodiment the reference module is an existing module of the electronic device.

In an embodiment the reference module is a peripheral device connectable to the electronic device.

In an embodiment the peripheral device is removably connected to the electronic device.

In an embodiment the reference module generates at least one analog signal from which the measurable output is derived.

In an embodiment the measurable output is at least one digital signal.

In an embodiment the bias is inherent in the electronic device.

In an embodiment the bias is inherent in the reference module.

In an embodiment the bias is a hardware bias.

In an embodiment the reference module includes one or more of: a camera module; a gyroscope module; an accelerometer module; and a compass module.

In an embodiment the measurable output from the camera module includes a chronological series of digital images.

In an embodiment the camera module includes a lens having a field of view and the images are captured when the field of view has a predetermined state.

In an embodiment the predetermined state comprises the field of view being at a low light state.

In an embodiment the predetermined state comprises the field of view being at a null light state.

In an embodiment the predetermined state comprises the field of view containing a particular shape and/or pattern.

In an embodiment the measurable output from the gyroscope module includes a chronological series of measurements.

In an embodiment each measurement is a respective digital signal indicative of angular acceleration measured by the gyroscopic module while the electronic device is at rest.

In an embodiment the measurable output from the compass module includes a chronological series of measurements.

In an embodiment each measurement is a respective digital signal indicative of an orientation measured by the compass module while the electronic device is at rest.

In an embodiment the reference module includes an electronic circuit having an output for providing the measurable output.

In an embodiment the electronic circuit includes an input and the measurable output is obtained for a predetermined input signal applied to the input.

In an embodiment the predetermined input signal is selected from a null signal; and a maximum signal.

In an embodiment the electronic circuit is an integrated circuit and the null signal is a logical zero signal and the maximum signal is a logical one signal.

In an embodiment the device interface is configured for: receiving an identification request to provide a first instance of the predetermined characterisation of the electronic device; and transmitting a device response to the identification request.

In an embodiment the device interface is configured for: receiving an identification request to provide a first instance of the predetermined characterisation of the electronic device; and transmitting a device response to the identification request.

In an embodiment the processor is responsive to the identification request for: prompting the reference module for the measurable output; producing the first instance of the characterisation; and generating a device response to the identification request that contains first data that is indicative of the first instance of the device characterisation.

In an embodiment the processor encrypts the first data.

According to a second aspect of the invention there is provided a method of operating an electronic device, the method including the steps of:
receiving with a device interface an authentication request to provide a second instance of a predetermined characterisation of the device transmitting with the device interface a device response to the request;
providing a measurable output from a reference module, wherein the measurable output includes a bias; and
providing a processor that is responsive to the request for: prompting the module for the measurable output; producing the second instance of the characterisation based upon the measurable output; and generating the device response containing second data that is indicative of the second instance of the device characterisation.

According to a third aspect of the invention there is provided a system for providing authentication data for a user device of a user, the system including:
a database for storing first data that is indicative of a first instance of a device characterisation derived from a static orientation of the device;
a system interface for: receiving from the device second data that is indicative of a second instance of the device characterisation; and transmitting the authentication data; and
an authentication module that is responsive to the first and second data to selectively generate the authentication data.

In an embodiment each instance of the device characterisation is derived from more than one static orientation of the device.

In an embodiment the interface receives temporarily spaced separate instances of the second data and the authentication module is responsive to the receipt of each instance to selectively generate respective instances of the authentication data.

In an embodiment each instance of the device characterisation is derived from a predetermined sequence of static orientations of the device.

In an embodiment the authentication module is responsive to a first request from a first party being received by the interface for selectively generating the authentication data.

In an embodiment the interface is responsive to the generation of the authentication data for transmitting that data to the first party.

In an embodiment the first instance of the device characterisation is a device signature that is derived from the static orientation.

In an embodiment the system includes a signature module that is responsive to third data from the user device for generating the first data.

In an embodiment the third data includes a unique identifier for the device.

In an embodiment the third data includes a UUID for the device.

In an embodiment the device signature is generated by the device and transmitted as third data to the interface.

In an embodiment the authentication module is responsive to the device signature and the second data to selectively generate the authentication data.

In an embodiment the user device includes:
a device interface for receiving a system request to provide the second instance of the device characterisation and for transmitting a device response;
a reference module that is responsive to the system request and at least one predetermined static orientation of the user device for producing the second instance of the characterisation; and
a computational module that is responsive to the second instance for generating the device response.

In an embodiment the reference module includes a plurality of accelerometers.

In an embodiment the reference module includes at least two accelerometers orientated orthogonally.

In an embodiment the reference module includes at least three accelerometers orientated orthogonally.

In an embodiment the instances of the characterisations are each derived from at least one measurement received from each of the accelerometers.

In an embodiment the user device includes a human machine interface (HMI) that is responsive to the system request for indicating to the user the current orientation of the device.

In an embodiment the HMI is responsive to the system request for indicating a target orientation for the user device.

In an embodiment the HMI is responsive to the system request for indicating a difference between the current orientation and the target orientation.

In an embodiment the HMI is responsive to the system request for indicating a substantial concordance between the current orientation and the target orientation.

In an embodiment the HMI is responsive to the indicating of the substantial concordance to indicate a further target orientation.

In an embodiment the indicating of the difference or the substantial concordance occurs in real-time.

In an embodiment the HMI includes a graphical user interface (GUI).

In an embodiment:
the database stores a user record for the user; and
the association module is responsive to the device providing the first instance of
the characterisation to the system interface for updating the user record.

In an embodiment the device has a communications address and the signature module is responsive to the communications address for generating the first data.

In an embodiment the signature module is responsive to the communications address for generating the device signature.

In an embodiment the communications address is one of: a telephone number; an email address; a text message address; or the like.

According to a fourth aspect of the invention there is provided a method for providing authentication data for a user device operated by a user, the method including the steps of:
storing in a database first data that is indicative of a first instance of a characterisation derived from a static orientation of the device;
providing a system interface for: receiving from the device second data that is indicative of a second instance of the characterisation; and transmitting the authentication data; and
providing an authentication module that is responsive to the first and second data to selectively generate the authentication data.

According to a fifth aspect of the invention there is provided a mobile communications device including:
a device interface for: receiving a system request to provide a second instance of a predetermined characterisation of the device; and transmitting a device response;
a reference module that is responsive to the system request and at least one predetermined static orientation of the device for producing the second instance of the characterisation; and
a computational module that is responsive to the second instance for generating the device response.

In an embodiment the reference module is responsive to a plurality of predetermined orientations for producing the second instance of the characterisation.

According to a sixth aspect of the invention there is provided a system for providing authentication data for an electronic device that generates a measurable output including a bias, the system including:
a database for storing first data that is indicative of a first instance of a device characterisation for the device that is derived at least in part from the bias;
a system interface for: receiving from the device second data that is indicative of a second instance of the device characterisation; and
an authentication module that is responsive to the first and second data to selectively generate the authentication data for the electronic device.

In an embodiment the interface is responsive to the authentication module for selectively transmitting the authentication data to a remote device.

In an embodiment the remote device is one or more of a POS device, a building access controller, a network device, a financial transaction gateway, or the like.

In an embodiment the electronic device includes a reference module for generating the measurable output.

In an embodiment the reference module is one or more of: a GPS module; a camera module; an accelerometer module; a compass module; a magnetometer module; a GUI module; a gyroscope module; a compass module; or the like.

In an embodiment the reference module generates the measurable output when the device is in a predetermined state.

In an embodiment the reference module generates the measurable output when the reference module is in a predetermined state.

In an embodiment the measurable output includes a plurality of temporally spaced individual outputs.

In an embodiment the electronic device is responsive to the measurable output for calculating the bias.

In an embodiment the electronic device is responsive to the plurality of individual outputs for calculating the bias.

In an embodiment the system includes a storage module that is responsive to the system interface receiving the second data for storing the second data in the database.

In an embodiment the second data is indicative of a plurality of second instances of the device characterisations and the authentication module is responsive to more than one of the plurality of second instances when selectively generating the authentication data.

In an embodiment the first data is indicative of a plurality of first instances of the device characterisation and authentication module is responsive to more than one of the plurality of first instances when selectively generating the authentication data.

In an embodiment the system interface receives the first data from the electronic device.

In an embodiment the system interface receives the first data from a remote data source.

According to a seventh aspect of the invention there is provided a method for providing authentication data for an electronic device that generates a measurable output including a bias, the method including the steps of:
storing in a database first data that is indicative of a first instance of a device characterisation for the device that is derived at least in part from the bias;
receiving with a system interface second data from the device that is indicative of a second instance of the device characterisation; and
being responsive with an authentication module to the first and second data to selectively generate the authentication data for the electronic device.

According to an eighth aspect of the invention there is provided a system for providing authentication data for an electronic device that generates a measurable output in response to a state of the device, the measurable output including a bias and the system including:
a database for storing first data that is indicative of a first instance of a device characterisation for the device that is derived at least in part from the bias;
a system interface for: receiving from the device second data that is indicative of a second instance of the device characterisation; and
an authentication module that is responsive to the first and second data to selectively generate the authentication data for the electronic device.

According to a ninth aspect of the invention there is provided a method for providing authentication data for an electronic device that generates a measurable output in response to a state of the device, the measurable output including a bias and the method including the steps of:
storing in a database first data that is indicative of a first instance of a device characterisation for the device that is derived at least in part from the bias;
receiving with a system interface second data from the device that is indicative of a second instance of the device characterisation; and
being responsive with an authentication module to the first and second data to selectively generate the authentication data for the electronic device.

According to a tenth aspect of the invention there is provided an electronic device including:
a device interface for: receiving an authentication request to provide a second instance of a predetermined characterisation of the device; and transmitting a device response to the request;
a reference module that provides a measurable output in response to a state of the device, the measurable output including a bias; and
a processor that is responsive to the request for: prompting the module for the measurable output; producing the second instance of the characterisation; and generating the device response containing second data that is indicative of the second instance of the device characterisation.

According to an eleventh aspect of the invention there is provided a method for operating an electronic device, the method including the steps of:
receiving with a device interface an authentication request to provide a second instance of a predetermined characterisation of the device;
transmitting with the device interface a device response to the request;
providing a measurable output from a reference module in response to a state of the device, the measurable output including a bias; and
being responsive with a processor to the request for: prompting the module for the measurable output; producing the second instance of the characterisation;
and generating the device response containing second data that is indicative of the second instance of the device characterisation.

According to a twelfth aspect of the invention there is provided an electronic device including:
a device interface for: receiving a request to provide an instance of a predetermined characterisation of the device; and transmitting a device response to the request;
a reference module that provides a measurable output including a bias; and
a processor that is responsive to the request for: prompting the module for the measurable output; producing the instance of the characterisation based at least in part upon the measurable output; and generating the device response containing response data that is indicative of the instance of the device characterisation.

In an embodiment the processor is responsive to the measurable output for calculating the bias.

In an embodiment the processor generates the device response such that the bias is able to be calculated from the response data.

According to a thirteenth aspect of the invention there is provided a method for operating an electronic device, the method including the steps of:
receiving with a device interface a request to provide an instance of a predetermined characterisation of the device;
transmitting with the device interface a device response to the request; providing a measurable output from a reference module, wherein the measurable output includes a bias; and
providing a processor that is responsive to the request for: prompting the module for the measurable output; producing the instance of the characterisation based at least in part upon the measurable output; and generating the device response containing response data that is indicative of the instance of the device characterisation.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, and unless otherwise specified, the use of the ordinal adjectives “first”, “second”, “third”, etc., to describe common objects, merely indicate that different instances of like objects are being referred to, and are not intended to imply that the objects so described must be in a given sequence, either temporally, spatially, in ranking, or in any other manner.

In the claims below and the description herein, any one of the terms “comprising”, “comprised of” or “which comprises” or the like is an open term that means “including at least the elements/features that follow, but not excluding others”. Thus, the term “comprising”, when used in the claims, should not be interpreted as being limitative to the means or elements or steps listed thereafter. For example, the scope of the expression “a device comprising A and B” should not be limited to devices consisting only of elements A and B. Any one of the terms “including” or “which includes” or “that includes”, as used herein, is also an open term that also means “including at least the elements/features that follow the term, but not excluding others”. Thus, the term “including” is synonymous with and means “comprising”.

As used herein, the term “exemplary” is used in the sense of providing examples, as opposed to indicating quality. That is, an “exemplary embodiment” is an embodiment provided as an example, as opposed to necessarily being an embodiment of exemplary quality or status.

### BRIEF DESCRIPTION OF THE DRAWINGS

Embodiments of the invention will now be described, by way of example only, with reference to the accompanying drawings in which:

FIG. 1 illustrates schematically an overview of a system according to an embodiment of the invention;

FIG. 2 illustrates schematically a smartphone for communicating with the system of FIG. 1;

FIG. 3 is an overview of the steps taken by a merchant (the first party) to enrol in the system of FIG. 1;

FIG. 4 is an overview of the steps taken to associate a user and a merchant making use of the system of FIG. 1;

FIG. 5 is an overview of the steps taken to authenticate a user with the system of FIG. 1; and

FIG. 6 is an overview of the steps taken to enrol a user with the system of FIG. 1 and to identify the user device.

### DETAILED DESCRIPTION

Described herein are systems and methods for providing authentication data for an electronic device.

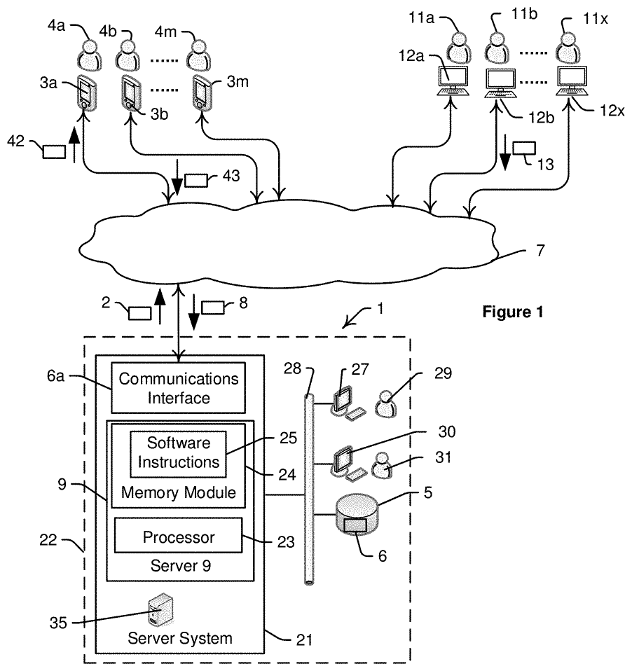

Referring to FIG. 1 there is schematically illustrated a system 1 for providing respective authentication data 2 for user devices 3 (including but not limited to smartphones 3a, 3b, . . . , and 3m) of respective users 4 (including but not limited users 4a, 4b, . . . , and 4m). System 1 includes a database 5 for storing first data 6 for each of devices 3 that is indicative of a first instance of a device characterisation derived from a sequence of three static orientations of the respective devices 3. A system interface, in the form of a communications interface 6a, receives from device 3, via a communications network 7, second data 8 that is indicative of a second instance of the device characterisation. Interface 6a also transmits the authentication data 2, as will be described below, via network 7. An authentication module, in the form of a server 9, is responsive to first data 6 and second data 8 to selectively generate authentication data 2.

System 1 is part of a larger online trading and payment system for facilitating the online purchasing of goods and/or services by users 4 from a plurality of parties in the form of merchants 11 (including but not limited to merchants 11a, 11b, . . . , and 11x) having virtual POS terminals provided by respective computers 12 (including but not limited to computers 12a, 12b, . . . , and 12x). In broad terms, when one of users 4—taking user 4a as an example—identifies in the usual manner an online transaction desirous of being made with one of merchants 11—taking merchant 11b as an example. This typically requires user 4a to have or be prepared to define an account with merchant 11b, where such an account will have a username and password that is used to identify user 4a to merchant 11b. Once the relevant transaction has been selected, computer 12b generates a first request 13 that is communicated to interface 6a of system 1 via network 7. Each merchant enrolled with system 1 has a unique merchant name which is selected by each individual merchant. Request 13 in this embodiment is a hash of at least the username and the merchant name for allowing system 1 to make an association between smartphone 3aand user 4a without having to know the username user 4a has with merchant 11b. (This will be described further below). Server 9 is responsive to request 13 from merchant 12b being received by interface 6a for selectively generating data 2 and for communicating data 2, via interface 6a and network 7, to computer 12b. The selective generation of data 2 is the authentication step, and is dependent upon predetermined communications between system 1 and smartphone 3a between the receipt of request 13 and the generation of data 2. This time period is referred to as the authentication period. These communications and other steps will be described in more detail below, and are centred upon making use of one or more static orientations of smartphone 3a during the authentication period as a key determinant as to whether data 2 will indicate a favourable or unfavourable authentication of user 4a.

In other embodiments system 1 is used for providing authentication data for other than online trading and payment systems. That is, system 1 is applicable to other online or networked operations which need not involve a financial transaction. Examples include generating authentication data in response to a request by a user to log on to a chat site or blog. In further embodiments system 1 is used to provide authentication data in response to a user attempting to log onto a public web service (for example, to access a public database such as that provided by the Australian Securities & Investments Commission, the corporate regulator in Australia) or a community web service such as operated by a sporting club. In further embodiments, system 1 provides authentication data in response to an access request such as a user requesting the opening a smart-door or the opening of a smart-lock, or an IoT device or other electronic device requesting access to a computer network or a communications network. In further embodiments, such as in industrial IoT (IIoT) applications, system 1 is used to audit the electronic devices included within a given facility or which have access to a give network by periodically or otherwise systematically requesting respective second data 8 from all, or selected ones, of the electronic devices. System 1 then ascertains the authenticity of the devices by reference to already held first data 6 for those respective devices. If abnormalities are detected remedial action is able to be taken. This could include, for example, raising an alert, scheduling a physical inspection of the device, preventing any further access to the network by the device, and the like. In this way, system 1 is also able to identify any electronic devices located at the facility, or which have access to the network, for which there is no corresponding first data 6. As these devices are not identified—for they are not enrolled in system 1—then remedial action is able to be triggered by system 1. Subject to software rules, this includes in some embodiments having the enrolment occur, or following one or more of the remedial actions described above

Returning to FIG. 1, the function of smartphones 3 and computers 12, and other such computing devices used instead of or in addition by users 4 and merchants 11, is to enable users 4 and merchants 11 to communicate and interact with system 1. Accordingly, users 4 are able to use respective smartphones or other computing devices (where configured to provide information about the static orientation of the device), while merchants 11 are able to use respective desktop or other computers, to initiate and affect that communication. Other computing devices are able to be used instead of desktop computers and smartphones. For example, the communication is able to be established with system 1 via computing devices such as tablet computers, laptop computers, notebook computers, PDAs, net-book computers, or other web-enabled or network enabled computing devices. Moreover, users 4 and merchants 11 are not limited to always using the same device to access and interact with system 1 during different sessions. System 1 also accommodates a given user having multiple smartphones (or other suitably enabled devices) for providing the required authentication during the authentication period.

System 1 includes a server system 21, which includes interface 6a in the form of a internet interface, for allowing the required communications sessions to be established to enable to interactions between each of smartphones 3 and system 1 and computers 12 and system 1. Although only a single interface is shown, it will be appreciated that, in other embodiments, more than one interface is used by system 1. The communications interface or interfaces are able to be enabled by an Internet connection, modem, Ethernet port, wireless network card, serial port, or the like, and will depend upon the nature and scale of system 1.

In some embodiments interface 6a includes a website. The term “website” should be read broadly to cover substantially any source of information accessible over the Internet or another communications network (such as WAN, LAN or WLAN) via a browser application running on a client terminal. In some embodiments, a website is a source of information made available by a server and accessible over the Internet by a web-browser application running on a client terminal. The web-browser application downloads code, such as HTML code, from the server. This code is executable through the web-browser on the client terminal for providing a graphical and often interactive representation of the website on the client terminal. By way of the web-browser application, a user of the client terminal (for example, users 4 and merchants 11) is able to navigate between and throughout various web pages provided by the website, and access various functionalities that are provided.

Server system 21 is physically or virtually located in a secure facility 22 (or a plurality of secure facilities) and includes a plurality of interlinked physical servers, one of which is server 9. It will be appreciated that typically a plurality of servers is used, although in some embodiments that includes virtual servers or services that in aggregate provide the functionality of server 21. It will also be appreciated that any servers used (and/or for any other physical or virtual servers employed in system 1) need not be co-located with the illustrated server and are able to be disposed at other physical or virtual locations. In some embodiments, for example those using third-party cloud-based computing infrastructure, server 21 and server 9 are able to be realised by a collection of virtual services that in aggregate provide the functionality of server 21 and server 9.

Each of the servers within server system 21 includes various components to allow operation. By way of example, server 9 includes a processor 23 coupled to a memory module 24. In other embodiments distributed resources or services are used. For example, in one embodiment server 9 includes a plurality of distributed servers having respective storage, processing and communications resources. In another embodiment, server 9 is a virtual server and/or a cloud server and/or a hosted server, or a collection of cloud-based services that in aggregate provide the services of server 9.

Memory module 24 includes software instructions 25, which are executable on processor 23.

Server 9 is coupled to database 5 (and any other databases physically or virtually within facility 22). In further embodiments the databases leverage memory module 24.

Other servers included in system 21 having similar components as described above with reference to server 9.

System 1 also includes a client terminal within facility 22 in the form of an administrator terminal 27 that is connected to a LAN 28. Terminal 27 runs a browser and is served up web pages from server system 21 using functionality similar to the delivery of web pages to computers 12. Terminal 27 is used by a supervisor 29 to, amongst other things, gain an overview of system 1, generate reports about various operating parameters of system 1, and to provide supervisory input. A further client terminal is provided in facility 22, in the form of a developer terminal 30, which is used by a developer 31 to, amongst other things, assist with the ongoing maintenance and development of system 1. It will be appreciated that different or additional terminals are also able to be included in facility 22. It will also be appreciated that those terminals are able to be replicated by the relevant supervisor 29, developer 31 accessing system 1 remotely from facility 22.

Users 4 and merchants 11 are all enrolled in system 1 to enable their ability to access the functionality that is described in this patent specification. This enrolment and access includes the individual users 4 and merchants 11 using respective computing devices, or like devices.

Whilst only three users 4 and three merchants 11 are explicitly illustrated in FIG. 1 it will be appreciated that, in use, system 1 accommodates many thousands or millions of such users and merchants each business day.

Users 4 individually enrol in system 1 by first using respective smartphones 3 to establish a communications session with system 1 and interact with an enrolment server 35. Server 35 facilitates the download to smartphone 3a of proprietary software (a software client) which then executes locally on smartphone 3a. In some embodiments the proprietary software is sourced from third party application stores (such as Apple's App Store or Google's Play). In other embodiments the third party software is stored on the merchant's server, or some other place.

The local execution of the software generates a unique user identification (UUID) that is associated with smartphone 3a. User 4a is then prompted to enter into the software client a word or phrase (referred to as a Lockname) that is meaningful to that individual. The software client then passes the UUID and the Lockname to system 1. Server 35, once confirming the uniqueness of the Lockname, associates it with the Phone UUID and stores it in a database 5 as part of first data 6 for smartphone 3a. User 4a is then prompted, by the execution of the software client, to orientate smartphone 3a in a sequence of predetermined static orientations. The data gathered by the software client during this operation is packaged and communicated to server 35 and also stored as part of data 6. In some embodiments, user 4a is prompted multiple times to orientate smartphone 3a in a sequence of static orientations and the results are separately communicated to server 35, which is then responsive to the received data for determining how to update data 6. It will be appreciated that in this embodiment data 6 is indicative of the measured output from the accelerometers in smartphone 3a when it is in the static orientations, together with any other associated data. Examples of such associated data include one or more of: timestamp data; location or other data for smartphone 3a; location or other data for the relevant one of merchant 11; data about or for user 4a; mathematically manipulated data derived from the measured output; and other such data that facilitates to calculation of the bias inherent in the accelerometers. In other embodiments the bias is calculated by software resident on smartphone 3a and communicated to server 35 and stored as part of data 6.

Merchants 11 individually enrol in system 1 by first using respective computers 12 to establish a communications session with system 1 and interact with server 35. Server 35 allows the modification of the online code run by the online POS software executed by computers 12 (web pages delivered to smartphones 3) to include an Application Programming Interface (API) that allows those web pages to call the functionality of system 1, as required. Additionally, each merchant establishing a communications session with system 1, and in particular with server 35, to obtain an API key using their preferred domain name. Server 35 then issues the API key using a secure connection between system 1 and computer 12. The API key also authenticates the API calls from the merchant's web pages, firstly to ensure security and privacy, and secondly to record transactions for later billing purposes.

The next step in the enrolment is to create a link between smartphone 3a and the online facility made available by merchant 11b. This occurs by user 3a logging into the online facility of merchant 11b by entering the username and password details established for user 3a with merchant 11b. This occurs in accordance with the security and identity policies usually observed by merchant 11b in its operation of the online facility. Merchant 11b then passes a hash of the merchant name and username to server 35. This prompts user 4a to enter their Lockname, which is communicated securely from smartphone 3a to server 35—that is, it is not accessible to computer 12b—to allow server 35 to associate the UUID for smartphone 3a with merchant 4a. This is done without revealing to system 1 the identity of user 3a or the username selected by user 3a for use on the facility offered by merchant 11b. This is achieved by a web redirect, whereby the session with the merchant 4a is transferred to the software on server 35, although transparently for the user, using Cross-Origin Resource Sharing (CORS). The user thus enters his, her or its Lockname in server 35 for association with the merchant name and the username hash.

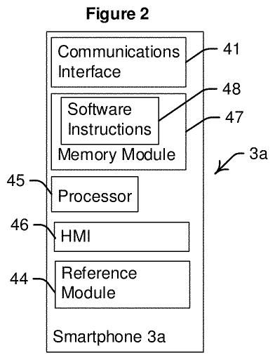

Smartphones 3 includes a combination of components for allowing the functionality of the embodiments to be realised. Taking, as an example, smartphone 3a, as schematically illustrated in FIG. 2, this includes a device interface, in the form of a communications interface 41, for receiving a system request 42 from system 1 to provide the second instance of the device characterisation and for transmitting a device response 43. A reference module 44, in the form of an existing onboard accelerometer, is responsive to request 42 and at least one predetermined static orientation of smartphone 3a for producing the second instance of the characterisation. A computational module, in the form of a processor 45, is responsive to the second instance for generating response 43. Smartphone 3a also includes a human machine interface (HMI) 46 having a GUI in the form of a touch screen. In other embodiments the HMI includes other or additional input/GUI devices such as one or more physical buttons, guides, scroll wheels, or the like, by which user 4a is able to provide input to the smartphone. Smartphone 3a also includes a memory module 47 including software instructions 48, which are executable on processor 45. These software instructions allow smartphone 3a to execute software applications, such as proprietary applications or web browser applications and thereby enable a user interface and allow communication with system 1.

In use, the second factor authentication provided by this embodiment is performed as follows, using the example of user 4a wishing to engage in an online transaction for goods and/or services offered by merchant 11b via computer 12b. User 4a, using smartphone 3a or another computing device, logs into his, her or its account with merchant 11b by entering the required username and password. Once the relevant transaction is identified and confirmed as progressing, computer 11b sends request 13 to system 1, where that request takes the form of the hash of the merchant name and username. This request is sent via a security API call with an API key. It will be appreciated that none of the details of the quantum or nature of the transaction need be sent to system 1. Upon receipt of request 13, system 1 associates the hash of the merchant name and the username with the Lockname and the UUID that are already held in database 5. System 1 then generates request 42, which is sent to smartphone 3a and any other registered smartphones for user 4a. Request 42 includes data indicative of merchant 11b. Processor 45 is responsive to request 42 for controlling HMI 46 of smartphone 3a to display the name of merchant 11b to user 4a and the desire to obtain from user 4a, using smartphone 3a, the desired second level authentication. If user 4a provides input to HMI 46 indicating consent, the processor 45 controls HMI 46 to guide user 4a in the orientation of smartphone 3a to allow the second instance of the characterisation to be generated. Once the required orientations have been achieved, processor 45 generates response 43, which includes second data 8, and which is communicated to system 1. Once response 43 is received by system 1, data 8 is extracted by server 9 and compared with data 6 to determine data 2 as being either “accepted” or “rejected”. Data 2 is then communicated to computer 11b, which is responsive to that data, in accordance with the software rules in place on computer 11b, for allowing merchant 11b to continue with the transaction or not.

It will also be appreciated that the above authentication is applicable to allowing user 4a to logon to the online facility offered by merchant 11a.

First data 6 and second data 8 are able to be derived from the bias in the inbuilt accelerometers in the relevant smartphone. Preferentially use is made of six accelerometers to measure gravity in six axes (x, −x, y, −y, z, −z). It will be appreciated that such smartphone accelerometers are typically analogue devices and are all subtly different. By suitably manipulating the orientation of the smartphone, the user is able to generate six separate sets of readings. The readings are then processed in six-dimensional space using a variant of second order gradient descent algorithm to produce a characterisation for the smartphone that identifies the bias of the accelerometers while measuring only gravity. This bias is the residual bias after calibration of the accelerometers done by the smartphone manufacturer. The first instance of this characterisation, which is done when enrolling the smartphone in system 1, is able to be used to define the first data 6 and to provide a device signature. By a process of statistical analysis, it is possible to uniquely identify the individual smartphone by this device signature, and to allow later sampled instances of the characterisation—that which define the second data 8 which is captured at each authentication event—to be compared with the first to generate the authentication data 2 with a high degree of confidence.

When the different instances of the characterisations are being compiled, the user is required to hold the smartphone steady and as parallel as possible to the direction of gravity. That is, the accelerometer readings are taken for a static or at least substantially static orientation, and not while the smartphone is in motion. This is done to better ensure that only gravity is measured by the accelerometers. In some embodiments, when determining the first instance of the characterisation, system 1 takes many tens of separate readings in each of the six directions. To assist the user with this process, the software client resident on the smartphone guides the user by providing instructions on which direction to turn or manipulate the smartphone. In some embodiments the user is provided with a ‘game-ified’ experience to encourage more accurate phone alignment. It is also possible to use specific sequences of static orientations to derive data 6.

For the second instances of the characterisations it is more typical to make use of only about three static orientations of smartphone 3. In other embodiments, however, use is made of more or less than three static orientations of device 3 to derive the data 8. For example, in one such specific embodiment use is made of a sequence of two static orientations. In another specific example, use is made of a sequence of six static orientations. The sequencing of the static orientations that have to be achieved by smartphone 3 at the time of generating the first and second instances of the characterisation is the same. However, in other embodiments, the number is different for the different instances. In other embodiments, the sequence for the relevant instance is determined by software resident on smartphone 3. In other embodiments, that software is informed by data received by smartphone 3 and which is able to randomise or otherwise determine the sequence, or to change the number of static orientations included in a given sequence, to provide additional confidence about the authentication that is performed. In further embodiments a plurality of static orientations is used, and the sequencing is not used as part of the authentication. That allows, for example, the sequence to be determined by the user 4 of smartphone 3 at the time of developing the device characterisation. In some embodiments only a single respective static orientation of the device is required to determine the second characterisation. In still further embodiments only a single respective static orientation of the device is required to determine the first characterisation. In a further embodiment, for example, involving a transaction having a value above a predetermined threshold, use is made of a plurality of static orientations of a plurality of computing devices associated with a single user.

During the collection of data 8, processor 45 controls HMI 46 to provide a visual and/or audible and/or haptic guide as to a target orientation to be achieved, and the orientation of smartphone 3 relative to that target orientation. This provides feedback to the user as to how the smartphone should be moved to achieve the target orientation. Once the orientation has been achieved, and maintained within predetermined tolerances for a predetermined duration, visual and/or audible feedback is provided to the user via HMI 46. Processor 45 then controls HMI 46 to present to the user the next target orientation in the sequence of orientations. This is repeated until the sequence is completed.

The user experience provided by HMI 46 in one embodiment includes an ‘artificial horizon’ like that found in an aircraft cockpit display. This visually represents ‘straight and level’ in two directions, thereby revealing the tilt of the smartphone away from the vertical. A red line, similar to the artificial horizon, represents the tilt of the smartphone away from vertical in the third direction. A cyan alignment line provides the target orientation. The user is required to align the artificial horizon, the red line and the cyan line. When this occurs, the smartphone is very close to parallel with gravity in the direction being measured.

In a further user experience provided by HMI 46 takes the form of two ‘bubbles’ that work similarly to those in a virtual ‘spirit level’. As the smartphone is brought close to the right orientation the two bubbles initially overlap visually and then directly overlie each other.

It will be appreciated by those skilled in the art, having also the benefit of the teaching herein, a driving factor in capturing data 8 is to reduce the impact of sampling noise to increase the confidence of authentication of smartphone 3 (or any other electronic device). In the above example, excessive noise in data 8 would corrupt the calculation of the bias of the accelerometers and hence reduce the confidence of an accurate authentication. The predetermined orientation of smartphone 3, and the use of multiple measures, are used to reduce the impact of such noise. In other embodiments different arrangements are used to reduce the noise. For example, in some embodiments a software algorithm is used to more closely analyse the measures to refine the calculation. In other embodiments, the bias of one or more of the accelerometers in the accelerometer module is precisely known or configured during manufacture to be of a certain magnitude to aid its determination for device 3.

Another factor to note is that accelerometers of the type used within smartphones have acceleration measures typically taken in three axes, even though only one axis is of interest at any given time. That is, for each measure there will be measures for the axis of interest and the other two axes. The result being that an x-axis accelerometer would have some component of acceleration measure even in y-axis and z-axis. Although it is possible to calculate those biases separately, in the embodiment described above, the measurements are taken at points where the desired axis are substantially isolated. Therefore, measures are taken at points where the smartphone or other device is maintained in a static location and orientated so as to align the axis of interest with the horizontal or vertical. Notwithstanding any true alignment of the axis of interest with the horizontal or vertical, there will remain a slight inclination at other axes due to human and other practical inaccuracies.

In summary, the following measures are used in the preferred embodiments to ensure higher quality data capture from three-axis accelerometers:
The smartphone or other device is orientated such that the acceleration on one axis of the accelerometer is as close as possible to the g (acceleration due to gravity). It is also possible to be responsive to the smartphone location to account for different g values at different earth locations. However, in other embodiments, this further refinement is not used as the difference in g at different locations can be much less than the bias being measured, at least for many devices. In any event, the measured value from the accelerometer is used if the measured value along the axis of interest is within a predetermined tolerance of the g value that is being used.
The acceleration measure on the axes other than the one being measured has acceleration as close to zero as possible. If this condition is not met, then the measured output is considered insufficiently clean to be used for further processing.
There are enough number of clean measurements in each direction to provide enough data points for approximating the curve fitting.

The above embodiment takes the accelerometer measurements as provided by the operating system (OS) of the smartphone. This typically means that a bias correction has already been done by that OS, and in particular by the device driver for the accelerometer within the OS. That being so, the bias calculated from the corrected measurements is much smaller than would be observed if the measured outputs were taken from the raw data initially used by the device driver. In some embodiments, use is made of a measurement module that connects within the device driver or otherwise sources the raw data measured by the device driver rather than the corrected measurements. In these embodiments it is typically possible to much more accurately calculate the bias and, hence, identify the accelerometer and the electronic device either with greater certainty or with a smaller number of sampled readings making up the measurable output.

In an embodiment a fixed number of data points or measured outputs are obtained from the accelerometers in the smartphone in each of the six directions, viz, X+, X−, Y+, Y−, Z+ and Z−. While other embodiments are able to use different numbers of measurements, from a practical point of view, with user devices the number is fixed to be optimal in terms of the user experience and the accuracy of the resultant calculation of the bias. In non-user devices, such as IoT devices, the user experience is given less or no weighting.

In the embodiment described above for smartphone 3, the measured output is in the form of a digital signal that gives rise to captured or sampled data. The data is derived from a plurality of temporally spaced apart analog accelerometer measurements. This captured data is processed to reduce the following errors:
The error caused due to numerical integration and differentiation is minimised by using symbolic integration and differentiation.
The error arising due to fitting a first order approximation by using second order approximation.

The measures above ensure that the error introduced due to modelling is minimised or at least reduced to provide a more accurate measurement of the bias.

The actual cost/optimisation function that needs to be minimised is:

(Xₘ−X₀)²/Xₛ²+(Yₘ−Y₀)²/Yₛ²+(Zₘ−Z₀)²/Zₛ²−g²

This function should be as close to zero as possible.

In the above function:
Xₘ is acceleration measured along the x-axis
Yₘ is acceleration measured along the y-axis
Zₘ is acceleration measured along the z-axis
X₀ is the offset/additive bias along the x-axis
Y₀ is the offset/additive bias along the y-axis
Z₀ is the offset/additive bias along the z-axis,
Xₛ is the sensitivity/multiplicative bias along the x-axis
Yₛ is the sensitivity/multiplicative bias along the y-axis
Zₛ is sensitivity/multiplicative bias along the z-axis
g is acceleration due to gravity.

In most general bias models, the bias is a combination of additive/offset bias and multiplicative/sensitivity bias. In the ideal scenario the additive bias is 0 and the multiplicative bias is 1. That is, if either additive or multiplicative bias does not exist the function is unaffected.

The above function is a second order multivariate equation and, more precisely, a three-dimensional function. After experimentation with this and various other functions, it has been found by the inventors that batch second order gradient descent with hessian is the best model for optimising operation with a smartphone. In geometric terms, this results in fitting a second order equation with the data points fed to it from the measured outputs. In other words, this methodology does not ignore the curvature of the function and is therefore more accurate than first order methods. Further, it converges faster if second order derivatives can be computed. As will be appreciated by the skilled addressee, it is not overly difficult to compute second order derivatives of the aforementioned objective function. Another advantage of second order method is that it can avoid saddle points and hence provide a robust methodology for standalone devices.

Gradient descent is a machine learning technique for curve fitting, and there are many variants of this technique available and which are suitable for use in the above embodiment. At each step of the method used in the above embodiment, the bias values are approximated and, when the minima are found, the bias values are taken as the best values.

As foreshadowed above, the accuracy of this method is able to be further improved, if required, by computing the bias for other axes as well when gravity is measured in one axis. In some embodiments the additional accuracy is not required, while in others the additional processing intensity needed to gain that accuracy is not available.

In other embodiments a different or additional reference module is used to gain the required measurable output. In one such other embodiment the reference module includes a gyroscope module having a plurality of gyroscopic sensors arranged on three normal axes. Similarly to the accelerometer module referred to above, the gyroscope module will typically provide data of all three axes in a single measurement. Accordingly, for the gyroscope module the measured output is preferentially a combined number of measurements obtained while the module is stationary at each of the three axes.

A no bias gyroscope would measure zero angular acceleration and hence the bias of the reference module is able to be computed. The computation would be very similar to accelerometer computation provided above, in which the following is to be minimised (ideally to zero):

(Wₓ−X_{off})²/Sₓ²+(W_{y}−Y_{off})²/S_{y}²+(W_{z}−Z_{off})²/S_{z}²

Where:
Wₓ is the angular acceleration about the x-axis as measured by the reference module.
X_{off} is the additive bias about the x-axis.
Sₓ is the multiplicative bias about the x-axis.
W_{y} is the angular acceleration about the y-axis as measured by the reference module.
Y_{off} is the additive bias about the y-axis.
S_{y} is the multiplicative bias about the y-axis.
W_{z} is the angular acceleration about the z-axis as measured by the reference module.
Z_{off} is the additive bias about the z-axis.
S_{z} is the multiplicative bias about the z-axis.

The batch gradient descent of second order with hessian has been found to provide a suitable practical method to compute the biases and for contributing to an accurate identification and authentication of the reference module.

In other embodiments a different or additional reference module is used to gain the required measurable output. In one such other embodiment the reference module includes a magnetometer module. In use, the user would be guided to move the electronic device in space in a predetermined manner. For example, one such predetermined manner includes progressing the electronic device spatially along a generally figure-eight path five times in continuous succession. Each iteration about the path is to take about three seconds to allow for sufficient data capture along the path during each pass. It will be appreciated that variations in the shape or the path, the number of iterations, and the duration of a pass along the path are available for selection to best match the state and/or sensitivity of the sensors in the reference module, the required accuracy of the identification and/or authentication, and other such factors. In some embodiments, the guidance provided to the electronic device concerning the path is determined remotely and the user only informed of the path (which is selected from a number of possible paths) and the timing for each pass until just prior to the identification or authentication being undertaken.

As the electronic device is progressed relatively slowly about the generally figure-eight shaped path the magnetometer module will sample a number of measures of the sensors within the module. These measures will include the minimum and maximum field measurements in each of the six principal directions, being +/−Mₓ, +/−M_{y}, and +/−M_{z}. Having obtained these minimum and maximum field measurements along three orthogonal axes, the average is able to be subtracted from the individual measurements. This allows for the cancellation of the effect of the Earth's magnetic field and due to any hard iron that is included in the electronic device. (For example, iron contained in a speaker included in the electronic device). Accordingly, the computation of an additive bias for the magnetometer module is possible using the following:

X_{off}=(Mₓₘₐₓ+Mₓₘᵢₙ)/2

Y_{off}=(M_{ymax}+M_{ymin})/2

Z_{off}=(M_{zmax}+M_{zmin})/2

Where:
X_{off} is the additive bias along the x-axis.
Mₓₘₐₓ is the maximum magnetic field measured along the x-axis.
Mₓₘᵢₙ is the minimum magnetic field measured along the x-axis.
Y_{off} is the additive bias along the y-axis.
M_{ymax} is the maximum magnetic field measured along the y-axis.
M_{ymin} is the minimum magnetic field measured along the y-axis.
Z_{off} is the additive bias along the z-axis.
M_{zmax} is the maximum magnetic field measured along the z-axis.
M_{zmin} is the minimum magnetic field measured along the z-axis.

In addition, the magnetometer module will have a bias due to any soft iron that interferes with the magnetometer measurements. This component of the bias is a multiplicative bias, which occurs in addition to the additive bias referred to above. The multiplicative bias is able to be computed using the following:

S_{delx}=(Mₓₘₐₓ−Mₓₘᵢₙ)/2

S_{dely}=(M_{ymax}−M_{ymin})/2

S_{delz}=(M_{zmax}−M_{zmin})/2

S_{avgdel}=(S_{delx}+S_{dely}+S_{delz})/3

Sₓ=S_{delx}/S_{avgdel}

S_{y}=S_{dely}/S_{avgdel}

S_{z}=S_{delz}/S_{avgdel}

Where:
S_{delx} is an intermediate delta value for calculating a multiplicative bias along the x-axis.
Sₓ is the multiplicative bias along the x-axis.
S_{dely} is an intermediate delta value for calculating a multiplicative bias along the y-axis.
S_{y} is the multiplicative bias along the y-axis.
S_{delz} is an intermediate delta value for calculating a multiplicative bias along the z-axis.
S_{z} is the multiplicative bias along the z-axis.
S_{avgdel} is the average delta.

Once Sₓ, S_{y} and S_{z} are calculated, the magnetic field at the time of measurement needs to be approximated sufficiently accurately to contribute to a high confidence identification and/or authentication of the electronic device. The Earth's magnetic field, elements that are part of the electronic device and incidental external elements that produce a magnetic field, or which include ferrous metals, can impact the measurements of the magnetometer module. For example, the Earth's magnetic field changes constantly, and generally varies between about 25 to 65 μT (0.25 to 0.65 Gauss). Therefore, to provide for a more accurate determination of the bias presented by the magnetometer module a correction is determined for these other situational and temporal factors. In particular, measure of the magnetic field is able to be computed as follows:

MFₓ=(Mₓ−X_{off})/Sₓ

MF_{y}=(M_{y}−Y_{off})/S_{y}

MF_{z}=(M_{z}−Z_{off})/S_{z}

Where:
MFₓ is a corrected magnetic field value for the x-axis.
Mₓ is a raw magnetic field value obtained by the reference module along the x-axis.
MF_{y} is a corrected magnetic field value for the y-axis.
M_{y} is a raw magnetic field value obtained by the reference module along the y-axis.
MF_{z} is a corrected magnetic field value for the z-axis.
M_{z} is a raw magnetic field value obtained by the reference module along the z-axis.

The above computation for MFₓ, MF_{y} and MF_{z} is able to be done using any one or more of the magnetometer measurements obtained during the traversing of the electronic device along the path.

Once the correction is determined, the bias computation is able to be strengthened using batch second order gradient descent with hessian. All the data measurements taken (to collectively define the measured output) are used in this embodiment.

The objective function to ideally equate to zero for calculating the bias is as follows:

(Mₓ−X_{off})²/Sₓ²+(M_{y}−Y_{off})²/S_{y}²+(M_{z}−Z_{off})²/S_{z}²−(MFₓ²+MF_{y}²+MF_{z}²)

The calculated bias is then able to be used to assist in the identification and/or authentication of the reference module and/or the electronic device.

In other embodiments a different or an additional reference module is used to gain the required measurable output. In one such other embodiment the reference module includes a camera module such as a pre-existing integrated camera module of an electronic device which is a smartphone.

Initially the camera module is controlled to allow for the capturing of the required data (that is, obtaining the measurable output) that is used by the main processor resident on the smartphone as input to the subsequent bias computation. In this embodiment, the capturing of the data involves the following steps:
Turning on the camera module. This can be done manually by the user (for example, by the user selecting the camera app on the smartphone) or automatically by the smartphone when prompted to provide a characterisation of the smartphone.
Having the active lens of the camera module facing a closely adjacent flat surface such that the image captured by the lens is substantially pitch black. (That is, such that a null signal is input to the camera lens).
Capturing three separate temporally spaced apart images, although taken in relatively quick succession. In some embodiments the user manually initiates the timing of the image capture, while in other embodiments the user simply initiates the first image capture and the software resident on the smartphone controls the timing of the subsequent image captures. In further embodiments a different number of images are captured.
Storing the images as a data file. In some embodiments the three images are stored as three separate data files, such as JPG files. However, in other embodiments different data file formats are used and different numbers of files are used.

In this embodiment, the bias computation is performed by software resident on the smartphone in response to the gather measurable output. The processing of the measurably output (which is in the form of a data file) to gain the bias measure for the camera module is as follows:
Process the JPG files to extract the RGB values for each pixel position.
Process one JPG file thus generated to compute the position of unnatural non-black pixels, viz. green, red or blue pixels and their respective clusters and any unnatural grey pixels in those clusters.
Compute the size of the cluster and the position (height to width ratio) for all of the non-black pixels.

In terms of the non-black pixels, there is one type of cluster where the non-black pixels change colour. That is, a data file for a first image in a captured sequence has a given pixel in one colour (say, red) while another data file for a second image in the same captured sequence has the same pixel as a different colour (say, blue). This typically denotes that the given pixel is a dead pixel and its position should not change over time. It is also possible to encounter other types of non-black clusters that retain their colour across pictures. There are also other pixels, which are referred to as stuck pixels, which are not used for bias computation as the colour of these pixels is able to change over time.

It is also possible to find grey scale pixel clusters where the colour of the pixel or cluster of pixels is lighter than pitch black. These are referred to as hot pixels which remain the same across multiple images captured within a short span of time such as a few seconds. However, hot pixels tend to change over longer time periods and hence, in this embodiment, are excluded from the calculation of the bias for the camera module.

It will be appreciated that the number of dead pixels and dead pixel clusters vary between camera modules although remaining substantively fixed for the same camera module. Hence, dead pixels and dead pixel clusters have been found to be a useful reference point in the calculation of the bias provided by a given camera module. It also follows that the number of elements impacting upon the calculation of the bias of one camera module—that is, the number of dead pixel clusters—is able to vary considerably from the number of elements impacting upon the calculation of the bias of another camera module.

It is also noted that a dead pixel cluster within a camera module is able to change over time, and typically by increasing in size. Therefore, when making use of the measurable output from a camera module, it is important to capture timestamp data for the data files and/or the bias calculation and/or the device characterisation. This allows, at least in some embodiments, for the authentication software (operating on the electronic device or remotely) to be responsive to the timestamp data for setting a tolerance on the size of a known cluster. For example, in this embodiment the tolerance to individual cluster size is allowed to increase over time, either progressively or stepwise.

Some electronic devices have either camera modules with multiple lens or multiple camera modules each having one or more lenses. Such a module or modules are also able to individually or collectively contribute to the measurable output for deriving an instance of a characterisation of the electronic device.

If a given electronic device has multiple camera modules, then each module should be identified and authenticated independently as the bias offered by those modules will be different to each other.

If a camera module has a single lens, then a recalculation of the bias during an authentication process (as distinct from an identification process) is able to be done by capturing a new sequence of images without needing to have the lens exposed to a pitch black (null signal). That is, the authentication process will be less sensitive to the background in the captured image as the position and size of the more heavily weighted reference clusters for the bias calculation have been identified.

Once the bias for a camera module is calculated (either locally on the electronic device or remotely by another computing device) there is a need to match the bias with a list of camera module biases stored remotely to ascertain if the authentication is successful. The bias computation follows the same process mentioned above, using the size and position of dead pixel clusters, typically also with the UUID or other identifier for the electronic device, to ascertain if the bias matches that earlier obtained from the electronic device for the camera module.

In some embodiments, the camera module includes a sensor—for example, a CCD array—that is manufactured to have one or more of the pixels that will provide a predetermined output for a predetermined input to the lens of the camera. In an exemplary embodiment this includes a number of pixels along an edge of the array that are spaced apart and which are dead pixels. In another exemplary embodiment, one or more of the sensors for a given pixel or pixels include a physical modification, such as a colour filter that is applied during manufacture to provide a given bias. Preferentially, such pixels are disposed at or near the edge of the array and are small in number relative to the total number of pixels in the array.

In other embodiments the reference module is another component part of the electronic device. By way of example, is some embodiments the reference module is a compass module. In further example embodiments, the reference module is a WiFi module or Bluetooth module. More particularly, in some embodiments the reference module includes an electronic circuit having an input for receiving a predetermined input signal and an output for providing the measurable output in response to the predetermined input signal being applied to the input. The predetermined input signal is able to be selected from a range of signals. However, for digital circuits (including integrated circuits) it has been found most beneficial for the predetermined input signal to be a null signal (that is, the input is held at a logical zero) or a maximum signal (that is, the input is held at a logical one). The measurable output (typically a current and/or voltage sampled at the output) will include the bias and will allow that bias to be calculated from the measurable output.

The reference modules used in many embodiments include an analog to digital converter for converting the analog signal provided by the sensor or transducer into a digital signal for defining all or part of the measurable output. In some embodiments, the reference module or modules include a plurality of analog to digital converters that are selectively controlled to contribute to the measurable output.

The above embodiments have described the calculation of a bias provided by a variety of reference modules that are associated with a smartphone. In the examples provided above the reference modules are peripheral devices for the smartphone, although integrated into the smartphone design and packaging. In other embodiments, use is made of other peripheral devices as a reference module. In some such embodiments, the peripheral device is removably connected to the smartphone to provide for the gathering of the measured output. The peripheral device is in some of those embodiments solely dedicated to providing the measured output, while in other such embodiments it has a further function in addition to providing the measured output.

In further embodiments the smartphone or other electronic device includes a plurality of reference modules and use is made of respective measured output from those modules when determining each, alternative, or different identifications and authentications. For example: an authentication for a first third party involves a first of the reference modules providing the measurable output for the bias calculation; an authentication for a second third party involves a second of the reference modules providing the measurable output for the bias calculation; and an authentication for a third third party involves the first and the second of reference modules providing respective measurable outputs, both of which are used for the bias calculation. Given the benefit of the above teaching it will be apparent to those skilled in the art that many other combinations are possible.

Some of the above described embodiments make use of reference modules having sensors or transducers that provide analog signals which are converted into measured outputs that are digital signals. The inherent physical variation between such analog devices, even if only within a small tolerance, result in nominally like electronic devices having different biases and, hence, different measured outputs even if the conditions sensed by the sensors of the respective electronic devices is the same. Accordingly, using the measured output to calculate the bias for a given electronic device allows for a signature to be developed for that device. This then allows for the initial identification and subsequent authentication of the device.

The above embodiments make use of software resident on the electronic device for calculating the bias (or biases) and for producing an instance of the device characterisation for the device. That device characterisation, which takes the form of a data file, is included in the device response that is sent remotely from the electronic device. In other embodiments, the software resident on the electronic device is primarily for collecting the measurable output and for producing the device characterisation such that the data file contains data indicative of the measurable output. This allows the remote recipient of the device response (for example, server 9 of FIG. 1) to extract the data file and independently determine the bias. The data file also includes timestamp and other data (such as an identifier for device 3) to facilitate the identification or authentication of device 3. For example, in some embodiments, the data file includes data indicative of the location of the electronic device to provide a further reference point against which to assess authenticity.

In the above examples the bias provided by the reference module is due to manufacturing tolerances, material qualities, and other such factors and are a normal part of the mass manufacture of electronic devices. In other embodiments, however, the bias for individual electronic devices is increased or amplified intentionally during manufacture by changing a physical property of one or more element in the electronic device. Preferentially, the physical change is to an integrated component or combination of components within the reference module so that they remain for practical purposes inherent and inseparable from the electronic device.

Accordingly, an embodiment includes a method of providing an electronic device having a reference module that provides a measurable output having a bias and a processor that is responsive to the measurable output for deriving and providing second data that is indicative of an instance of a characterisation of the device.

According to another embodiment there is provided a method of manufacturing an electronic device including the steps of: including within the device a reference module that provides a measurable output having a bias, wherein the bias is at least in part determined by manufacturing tolerances.

According to another embodiment there is provided a method of manufacturing an electronic device including the steps of: including within the device a reference module that provides a measurable output having a bias, wherein the bias is at least in part determined by one or a combination of selected components. Preferentially, the method incudes the further step of integrating the one or a combination of selected components with the module.

It will be appreciated that the manufacturer of electronic devices (or a related party) is able to obtain and store the first data for the electronic devices. That stored first data is able to be selectively supplied to third party authentication platforms (for example, POS authentication platforms such as system 1) and/or is able to be retained by the manufacturer or the related party to facilitate later authentication of the devices by that manufacturer. This allows the manufacturer to more accurately managing ongoing support for the devices and to manage other issues such as warranty claims, software updates, and the like. This is particularly advantageous for IoT devices which may otherwise not gain the benefit of such attention.

IoT devices encompass many different types of devices, including for example home appliances, personal medical monitors, energy (and other utility) management devices, and many others. By having these devices authenticated through the use of the methods of the embodiments, it is possible to gain additional comfort about the legitimacy of the devices that are connected and, hence, the appropriate use of the data that is being collected by and communicated between those devices. System 1, in the context of IoT devices, works similarly in requesting the second data and undertaking the authentication. This is able to be provided by the operator of system 1 as a service to the owner or user of the electronic device and can be performed periodically, randomly or otherwise to confirm the authenticity of the devices detected on a given network. It also allows system 1 to provide an audit function of the devices and to alert the user of any new devices and/or any unauthorised devices. In some embodiments, system 1 is instantiated on a laptop computer, smartphone or other computing device of the user to allow self-administration of the authentication procedures for the network of that user. However, in other embodiments, system 1 is operated as a service which is provided to large numbers of users.

According to another embodiment there is provided a method for providing authentication data 2 for a user device 3 operated by a user 4, the method including the steps of:
storing in a database 5 first data 6 that is indicative of a first instance of a characterisation derived from a static orientation of device 3;
providing a system interface 6a for: receiving from device 3 second data 8 that is indicative of a second instance of the characterisation; and transmitting the authentication data 2; and
providing an authentication module, in the form of server 9, that is responsive to first data 6 and second data 8 to selectively generate authentication data 2.

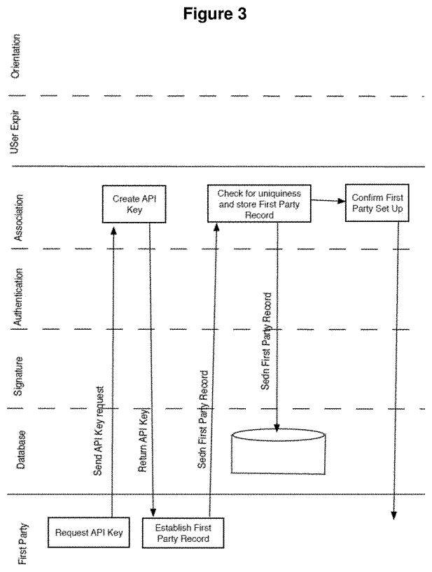

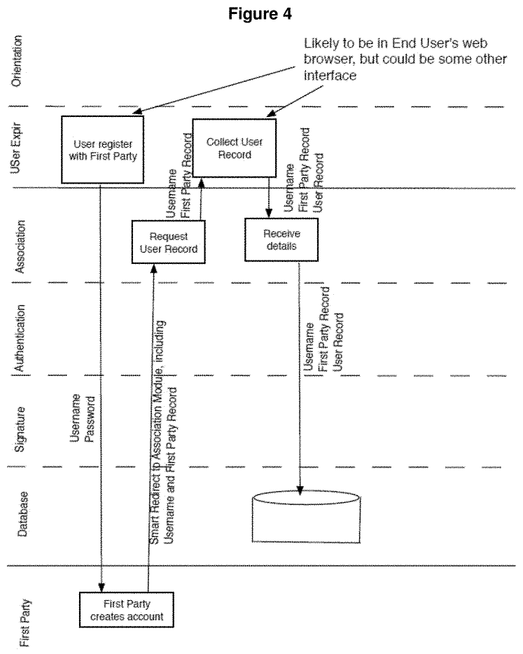

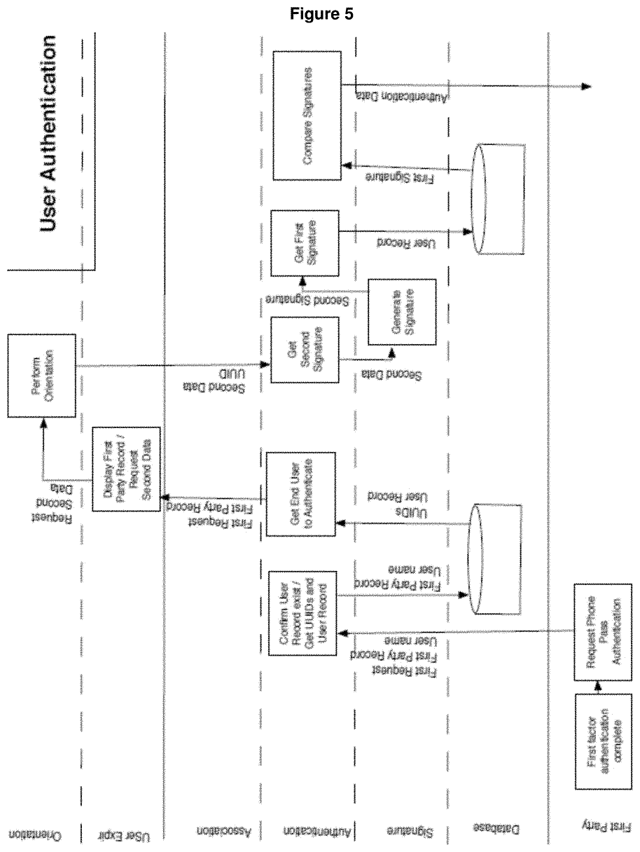

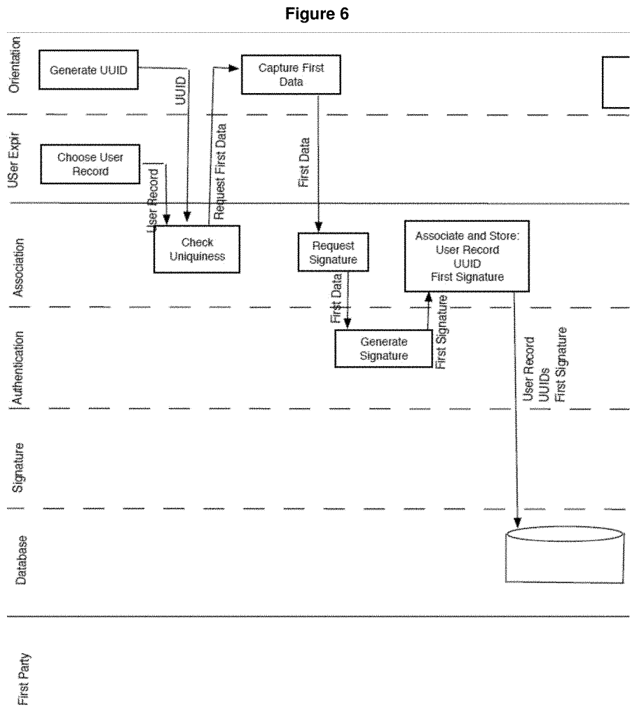

The above method, and other steps involved in the operation of system 1, is represented graphically in the flow diagrams of FIGS. 3 to 6.

According to another embodiment of the invention there is provided a mobile communications device 3 including:
a device interface 41 for: receiving a system request 42 to provide a second instance of a predetermined characterisation of the device 3; and transmitting a device response 43;
a reference module 44 that is responsive to system request 42 and at least one predetermined static orientation of device 3 for producing the second instance of the characterisation; and
a computational module 45 that is responsive to the second instance for generating device response 43.

According to another embodiment there is provided a system for providing authentication data 2 for an electronic device 3 that generates a measurable output in response to a state of device 3. The measurable output includes a bias and the system includes:
database 5 for storing first data 6 that is indicative of a first instance of a device characterisation for device 3 that is derived at least in part from the bias;
a system interface 6a for: receiving from device 3 second data 8 that is indicative of a second instance of the device characterisation; and
an authentication module, in the form of server 9, that is responsive to the first data 6 and second data 8 to selectively generate the authentication data 2 for device 3.

In some embodiments the state of the device is a physical state such as:
The device being maintained in a static orientation. For example, by having a predetermined surface of the device lying on a substantially horizontal surface, or by having the user maintain the device in some such orientation, or by having a predetermined sensor zeroed at the orientation of the device so that the bias is able to be assessed based upon the subsequent output of the sensor to a predetermined input.
A predetermined state of a sensor or other input. For example, the state of having a camera lens covered to provide an effective null input to the CCD device associated with the camera module. Another example is to have the camera lens focused on a predetermined image of known characteristics.

In another embodiment there is provided an electronic device 3 including:
a device interface 41 for: receiving a request to provide an instance of a predetermined characterisation of device 3; and transmitting a device response to the request;
a reference module 44 that provides a measurable output including a bias; and
a processor 45 that is responsive to the request for: prompting module 44 for the measurable output; producing the instance of the characterisation based at least in part upon the measurable output; and generating the device response containing response data that is indicative of the instance of the device characterisation.

In some embodiments the processor calculates the bias and the instance of the characterisation is indicative of the calculation. However, in other embodiments, the processor does not calculate the bias and the instance of the characterisation is indicative of the measurable output. In the latter case, the recipient of the response data—for example, server 9—extracts data indicative of the measurable output from the response data and thereafter calculates the bias so as to then perform either an identification of device 3 or an authentication of device 3.

The major advantages collectively provided by the above embodiments include:
Enabling a physically secure identification of an electronic device, based upon a signature inherent in the device itself, not just the software resident on the device.
Making use of a hardware bias specific to an individual electronic device, which is not able to be practically altered post-manufacture.
Allowing for more secure devices, such as user devices, to selectively undertake the bias calculation locally and to include the results of that calculation in the second data. The selection of circumstances is able to be based upon the nature of the authentication, the nature of the transaction for which the authentication is sought, the location of any one or more of the parties, the history of any one or more of the parties, and the like.
Allowing for less secure device, such as an IoT device or an IIOT device, to provide the second data which is indicative of the measurable output such that the bias calculation is able to occur remotely from the IoT device. In some embodiments the measurable output is included in the second data is a raw form, whereas in other embodiments it is manipulated locally by the device to provide noise correction, compression, encryption or other such processing.
Taking advantage of manufacturing tolerances to allow for the accurate identification and authentication of devices.
The ability to accentuate or otherwise shape a bias of the device during manufacture to allow for greater accuracy during the identification and authentication steps.
Allowing multiple reference modules to be accessed for the same authentication or accessed sequentially, alternately, cyclically, randomly or otherwise for successive authentications of the device.
Applicability to user devices and standalone electronic devices.
Providing a fully automated and scalable two-factor authentication.
Allowing the broader application of two-factor authentication to online services.
Allowing, after initial enrolment:
   i) Anonymous authentication by users.
   ii) The use of smartphones and mobile devices as the basis of the user authentication.
   iii) Cloud-based authentication system, thereby reducing the cost and complexity of two-factor authentication for providers of online services.
   iv) The ability to provide virtual ‘spare key’ services to end users to enable recovery of keys in the event of a lost device without requiring a service desk.
A secure, cost-effective, statistically reproduce-able and reliable methodology for characterisation of a smartphone or similar networkable device.
Easily compatible with existing one-factor authentication system.
Enhances the security of on-line services by providing an extra layer of security for individuals.
Uniquely identifies an electronic device by developing a device signature for the device.
Allows the anonymous linking of the signature to an online identity of a user or other party associated with the device.
When a user logs into an online service, either using the mobile device or another computing device, using his, her or its regular username and password, an alert will be generated on the smartphone. The user is then able to manipulate the smartphone to allow a fresh instance of the characterisation to be captured and used to validate the login, thereby allowing the online service to be validated.
Users of the embodiments are protected from password guessing and password theft attacks, including email phishing, password file thefts and man-in-the-middle attacks.
Networks are better protected from unauthorised access by IoT devices.
Allowing for a range of authentications of electronic devices.
Accommodating changing authentication processes in response to changing threat levels, size of transaction, access sensitivities, and the like.

### CONCLUSIONS AND INTERPRETATION

It will be appreciated that the disclosure above provides various significant systems and methods for providing authentication data for a user device of a user.

Unless specifically stated otherwise, it is appreciated that throughout the specification terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data—for example, from registers and/or memory—to transform that electronic data into other electronic data that, for example, may be stored in registers and/or memory. A “computer” or a “computing machine” or a “computing device” or a “networked device” or a “computing platform” may include one or more processors.

Reference is made in this specification to “data”. This term is used to describe groupings of information for storage or transmission. That is not to imply that the information need be all stored together or transmitted together, simply that the data, however stored or transmitted, provides a functional whole when assembled or accessed.

The methodologies described herein are, in one embodiment, performable by one or more processors that accept computer-readable (also called machine-readable) code defining a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, for example, a liquid crystal display (LCD) or a cathode ray tube (CRT) display or the like. If manual data entry is required, the processing system also includes an input device such as one or more of an alphanumeric input unit such as a keyboard, a pointing control device such as a mouse, touchpad, roll pad and so forth. The term “memory unit” as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (for example, software, which includes application software) including a set of instructions to cause performing, when executed by one or more processors, one of more of the methods described herein. Note that when the method includes several elements—for example, several steps—no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in, a computer program product.

In alternative embodiments, the one or more processors operate as a standalone device or may be connected—for example, networked to other processor(s)—in a networked deployment. The one or more processors may operate in the capacity of a server or a user machine (such as a user device or a client device) in server-user network environment, or as a peer machine in a peer-to-peer or distributed network environment. The one or more processors may form in part a personal computer (PC) (also referred to as a desktop computer), a tablet PC, a set-top box (STB), a Personal Digital Assistant (PDA), a cellular telephone, a web appliance, a network router, a smart phone, a switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described, in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions—for example, a computer program—that is for execution on one or more processors—for example, one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium—for example, a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media—for example, a centralized or distributed database, and/or associated caches and servers—that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to include, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention, unless specifically defined in a given claim, is not limited to any particular implementation or programming technique and that the invention may be implemented using any appropriate techniques for implementing the functionality described herein. The invention as defined by a given claim is not limited to any particular programming language or operating system unless that programming language or operating system is explicitly defined in that claim.

It should be appreciated that in the above description of exemplary embodiments of the invention, various features of the invention are sometimes grouped together in a single embodiment, Figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some, but not other, features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noted that the term “connected”, when used in the claims, should not be interpreted as being limited to direct connections only. Thus, the scope of the expression “a device A connected to a device B” should not be limited to devices or systems wherein an output of device A is directly connected to an input of device B. It means that there exists a path between an output of A and an input of B, which may be a path including other devices or means. “Connected” may mean that two or more elements are either: in direct physical contact, or electrical contact, or communicative contact with each other; or not in direct physical contact, or electrical contact, or communicative contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. Functionality may be added or deleted from the block diagrams and operations may be interchanged among functional blocks. Steps may be added or deleted to methods described within the scope of the present invention.

1.-20. (canceled)

21. A system, comprising:
one or more processors; and
a non-transitory computer readable medium storing a plurality of instructions, which when executed, cause the one or more processors of an electronic device to:
receive, by a device interface of the electronic device, an authentication request to provide an instance of a predetermined characterization of the electronic device;
prompt, by the electronic device, a reference module for a measurable output, the measurable output including a bias;
generate, by the electronic device, the instance of the predetermined characterization of the electronic device based on the measurable output;
generate, by the electronic device, a device response containing second data, the second data being indicative of the instance of the predetermined characterization of the electronic device;
transmit, by the electronic device, the device response.

22. The system of claim 21, wherein the reference module is selected from the group consisting of a camera module, a gyroscope module, an accelerometer module, and a compass module.

23. The system of claim 22, wherein the measurable output from the camera module includes a chronological series of digital images.

24. The system of claim 22, wherein the measurable output from the gyroscope module includes a chronological series of measurements.

25. The system of claim 24, wherein each measurement in the chronological series of measurements is a respective digital signal indicative of an angular acceleration measured by the gyroscope module while the electronic device is at rest.

26. The system of claim 22, wherein the measurable output from the compass module includes a chronological series of measurements.

27. The system of claim 26, wherein each measurement in the chronological series of measurements is a respective digital signal indicative of an orientation measured by the compass module while the electronic device is at rest.

28. The system of claim 22, wherein the accelerometer module includes a plurality of accelerometers.

29. The system of claim 28, wherein the accelerometers module obtains measurements along respective orthogonal axes.

30. The system of claim 28, wherein at least one measurement is received from each of the accelerometers, and each measurement being used to derive the instance of the predetermined characterizations.

31. The system of claim 21, wherein the reference module includes an electronic circuit having an output for providing the measurable output

32. The system of claim 31, wherein the electronic circuit includes an input, and wherein the measurable output is obtained for a predetermined input signal applied to the input

33. A method comprising::
receiving an authentication request at an electronic device, the authentication request to provide an instance of a predetermined characterization of the electronic device;
prompting a reference module for a measurable output, the measurable output including a bias;
generating the instance of the predetermined characterization of the electronic device based on the measurable output;
generating a device response containing second data, the second data being indicative of the instance of the predetermined characterization of the electronic device;
transmitting the device response.

34. The method of claim 33, further comprises determining a nature of the prompting of the reference module.

35. The method of claim 33, wherein during the prompt step, the electronic device further includes a plurality of reference modules, wherein one or more reference modules are selected from the plurality of reference modules, each of the one or more selected reference modules being prompted for measurable output.

36. The method of claim 33, wherein the reference module generates at least one analog signal from which the measurable output is derived.

37. The method of claim 36, wherein the measurable output is at least one digital signal.

38. The method of claim 33, wherein the bias is inherent in the electronic device.

39. The method of claim 38, wherein the bias is inherent in the reference module.

40. The method of claim 38, wherein the bias is a hardware bias.
